(19) United States
(12) Patent Application Publication
(10) Pub. No.: US 2003/0095235 A1
(43) Pub. Date: May 22, 2003

(54) Rotary imaging device

(76) Inventor: Hsu-Jung Tsai, Taipei (TW)

Correspondence Address: Hsu-Jung Tsai, 235 Chung-Ho, Box 8-24, Taipei, TW

(21) Appl. No.: 10/274,937

(22) Filed: Oct. 17, 2002

(30) Foreign Application Priority Data
Nov. 22, 2001 (TW) 090220225

(51) Int. Cl. G03B 25/00

(52) U.S. Cl. 352/99

(57) ABSTRACT

A rotary imaging device has a hollow body. A wall of the body is formed with a window. An interior of the body has a stopping piece protruding from the wall. An outer side of the rotary shaft is installed with a rotary shaft mounted within the body. A periphery of the rotary shaft has a plurality of sheets with figures being depicted or printed thereon. The rotary shaft is driven to rotate the sheets along a predetermined orientation; and outer ends of the sheets resist against the stopping piece so as to stop intermittently to present an effect as playing movies. Music machine center or chip can be added to the rotary imaging device so as to present image and music at the same time. Furthermore, a pen sharpener can be added to the rotary imaging device.

### BACKGROUND OF THE INVENTION

The present invention relates to imaging devices, and particularly to a rotary imaging device which can present continuous images as a movie and moreover, other functions can be appended to the rotary imaging device so as to present various effects.

FIG. 1 shows a prior art game for showing a plurality of continuous images as a movie, where the images are illustrated one by one by rapidly leafing through pages of a book. However, this prior art is too rough to present a preferred effect.

Currently, images are illustrated electronically by presenting a large amount of films with images thereon to present a movie. This prior art way need a higher cost and the images must be formed on the films by cameras.

Therefore, there is an eager demand for a novel design which can present continuous images with a lower cost and a preferred image quality.

### SUMMARY OF THE INVENTION

Accordingly, the primary object of the present invention is to provide a rotary imaging device. The rotary imaging device has a hollow body. A wall of the body is formed with a window. An interior of the body has a stopping piece protruding from the wall. An outer side of the rotary shaft is installed with a rotary shaft mounted within the body. A periphery of the rotary shaft has a plurality of sheets with figures being depicted or printed thereon. The rotary shaft is driven to rotate the sheets along a predetermined orientation; an outer ends of the sheets resist against the stopping piece so as to stop intermittently to present an effect as playing movies. Music machine center or chip can be added to the present invention so as to present image and music at the same time. Furthermore, pen sharpener may be used in the present invention.

The various objects and advantages of the present invention will be more readily understood from the following detailed description when read in conjunction with the appended drawing.

### BRIEF DESCRIPTION OF THE DRAWINGS

FIG. 1 is schematic view of a prior art imaging book.

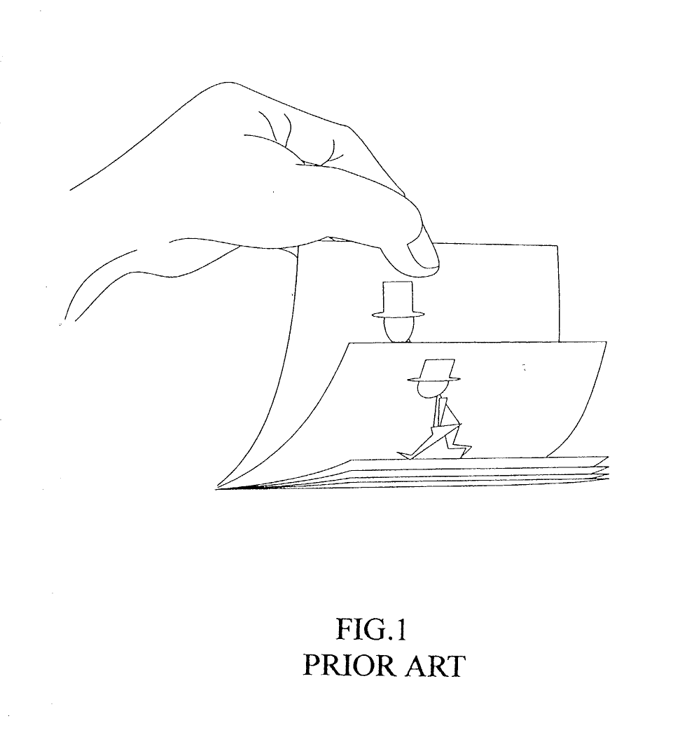

FIG. 2 is an exploded perspective view of the present invention.

FIG. 3 is a schematic perspective view of the present invention.

FIG. 4 is an assembled cross section view of the present invention.

FIG. 5 shows one example of the figures drawn on the sheets.

FIG. 6 is an exploded perspective view of another embodiment of the present invention.

FIG. 7 is an exploded perspective view of a further embodiment of the present invention.

### DETAILED DESCRIPTION OF THE PREFERRED EMBODIMENTS

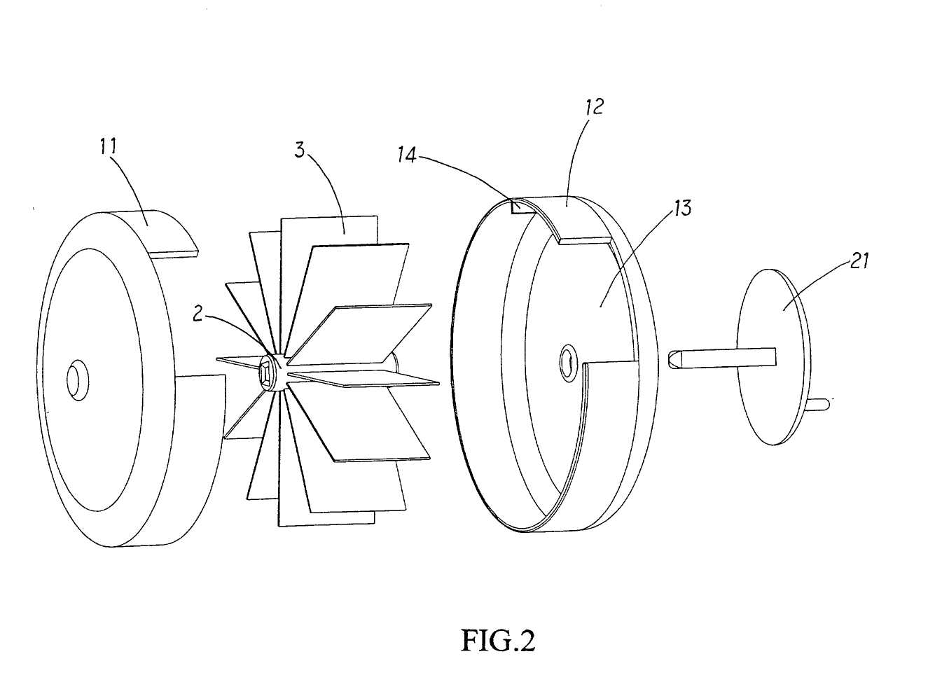

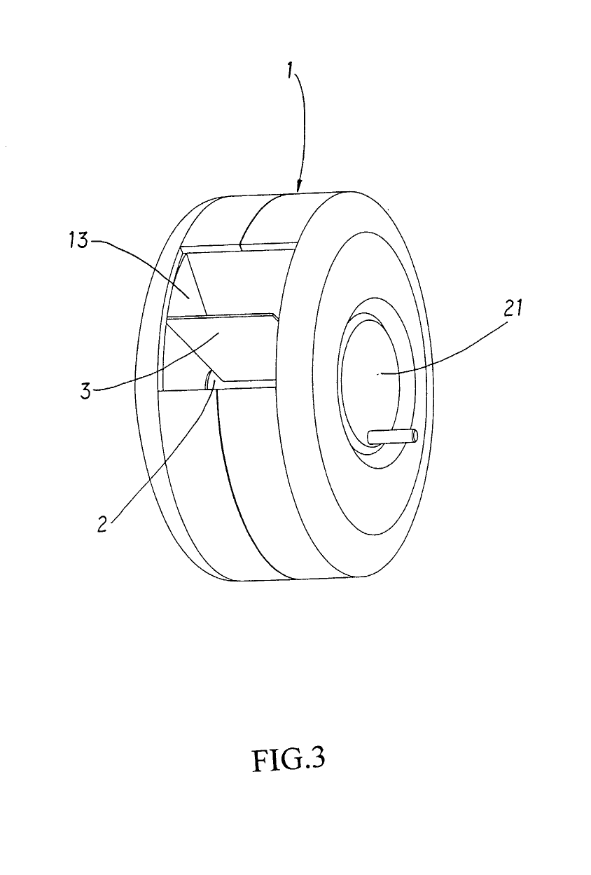

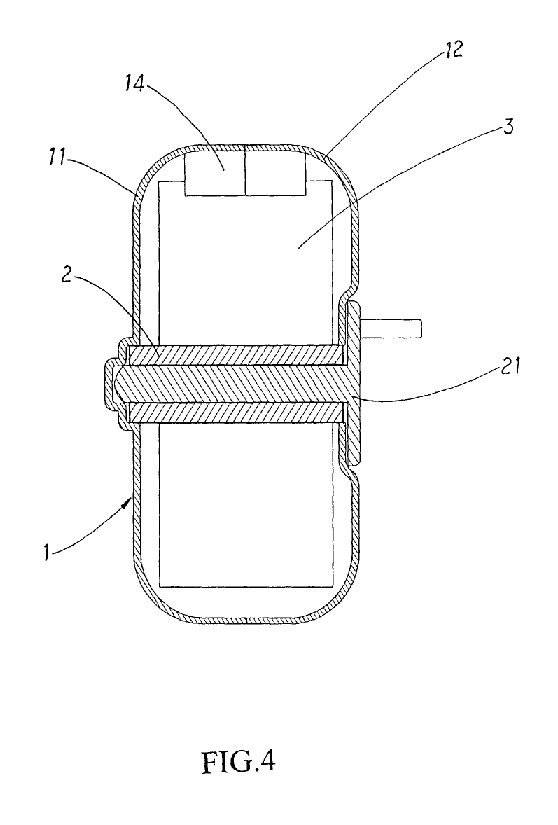

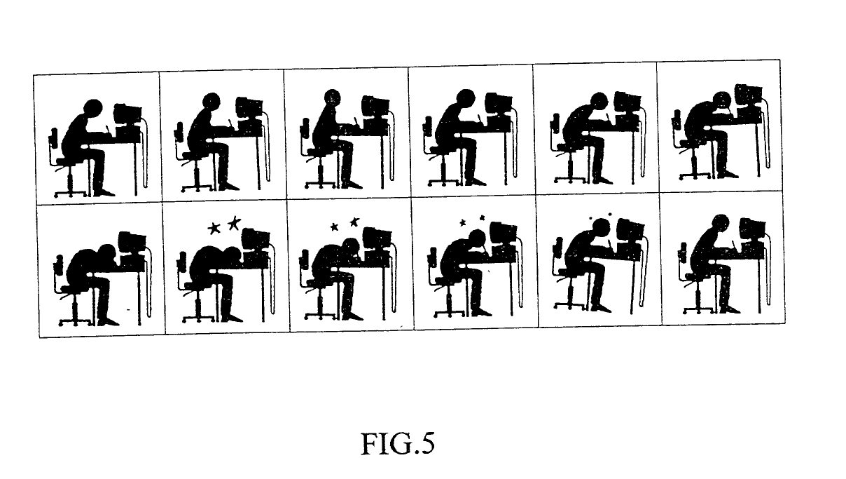

Referring to FIGS. 2 to 4, the rotary imaging device of the present invention is illustrated. The body 1 is a hollow body formed by a left casing 11 and a right casing 12. A wall of the body is formed with a window 13, and interior of the body 1 has a stopping piece 14 protruding from the wall. An outer side of the rotary shaft 2 is installed with a rotary disk 21 and the rotary shaft 2 is mounted within the body 1. A periphery of the rotary shaft 2 has a plurality of sheets 3 with figures are depicted or printed thereon. The rotary shaft 2 is driven to rotate the sheets 3 along a predetermined orientation. Outer ends of the sheets 3 resist against the stopping piece 14 so as to stop intermittently. When the rotary shaft 2 rotates continuously, sine the sheets 3 are flexible and distal ends of the sheets 3 will bend slightly so as to release from the stopping effect of the stopping piece 14. As a result, the sheets 3 will move with a higher speed due to an elastic force. Thereby, when driving the rotary shaft 2 to drive the sheets 3 to rotate along a predetermined direction (referring to FIG. 5), viewing from the window 13, it has an effect as playing a movie.

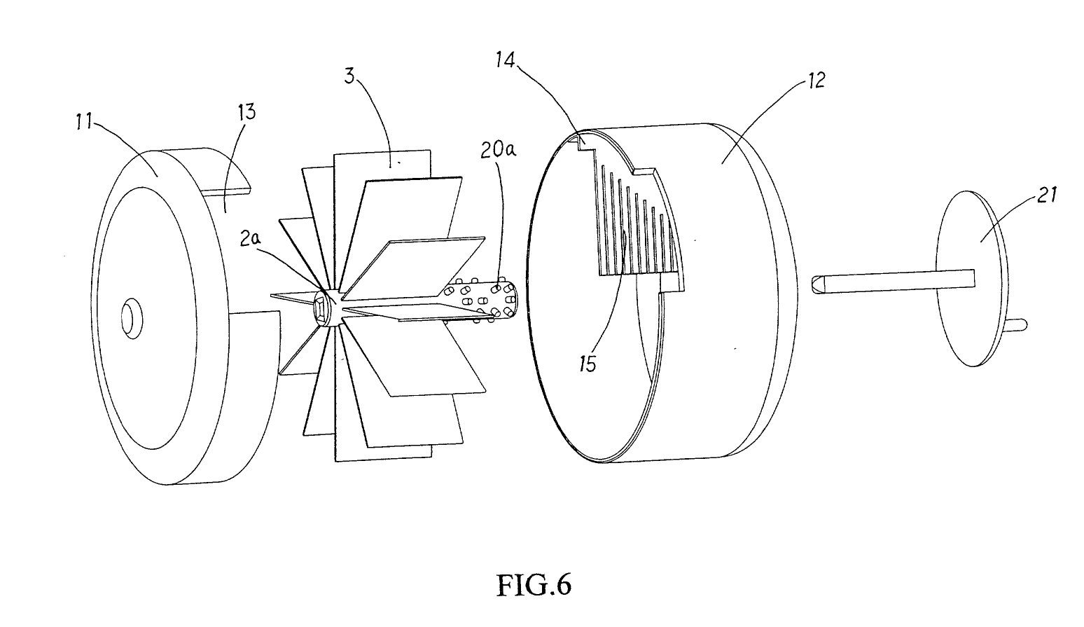

Next, referring to FIG. 6, the exploded perspective view of another embodiment of embodiment is illustrated. The radial surface of the rotary shaft 2a is formed with a plurality of noses 20a, and the wall of the body has a reed 15 so as to form a machine center of a music box. When the rotary shaft 2a is driven, by the sheets 3, a movie and a music effect are played at the same time.

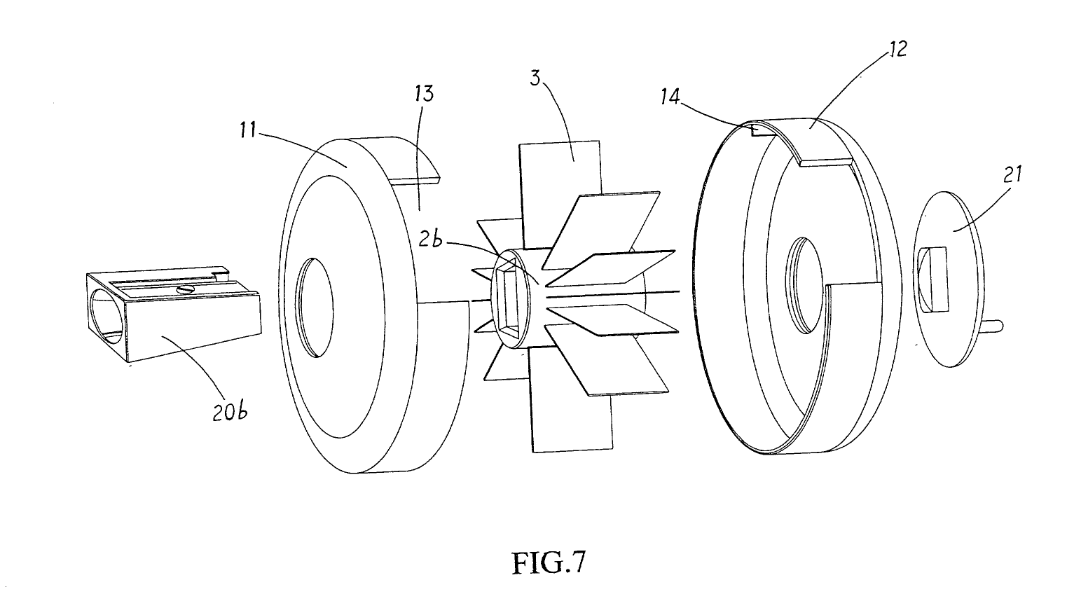

Referring to FIG. 7, another exploded perspective view of a further embodiment of the present invention is illustrated. An outer end of the rotary shaft 2b is formed with a pen sharpener 20b. A pen (not shown) can be inserted into the pen sharpener. When the rotary shaft 2b rotate, the pen sharpener 20b serves to cut the pen. Thereby, the present invention is a multi-functional device.

Moreover, in the present invention, the driving of the rotary shaft 2 can be performed by a motor, gears, or springs, etc. Moreover, as the rotary shaft 2 rotate, it can be used to drive a music chip so as to play music. Music machine center or chip can be added to the present invention so as to present image and music at the same time. Furthermore, a pen sharpener may be used in the present invention.

In the present invention, the sheets are made of elastic and flexible paper or plastics. The figures are continuous drawing, or each sheet is painted with colored blocks.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A rotary imaging device having a hollow body; a wall of the body being formed with a window; an interior of the body having a stopping piece protruding from the wall; an outer side of the rotary shaft being installed with a rotary shaft mounted within the body; a periphery of the rotary shaft having a plurality of sheets with figures being formed thereon; the rotary shaft being driven to rotate the sheets along a predetermined orientation; and outer ends of the sheets resist against the stopping piece so as to stop intermittently to present an effect as playing movies.

2. The rotary imaging device as claim in claim 1, wherein the sheets are made of elastic and flexible paper or plastics.

3. The rotary imaging device as claim in claim 1, wherein each sheet is painted with colored blocks.

4. The rotary imaging device as claim in claim 1, wherein an end of the rotary shaft is installed with a rotary disk for manually driving the rotary shaft to rotate.

5. The rotary imaging device as claim in claim 1, wherein the rotary shaft is driven by one of a group containing a motor, gears and springs.

6. The rotary imaging device as claim in claim 1, wherein a shape of the body is selected from a group containing animals, stationeries, articles for daily use and food materials.

7. The rotary imaging device as claim in claim 1, wherein a radial surface of the rotary shaft is formed with a plurality of noses, and the wall of the body has a reed so as to form a machine center of a music box; when the rotary shaft is driven, by the sheets, a movie and a music effect are played at the same time.

8. The rotary imaging device as claim in claim 6, wherein as the rotary shaft rotate, it is used to drive a music chip so as to play music.

9. The rotary imaging device as claim in claim 1, wherein an outer end of the rotary shaft is formed with a pen sharpener for cutting a pen as a pen is inserted into the pen sharpener.
